(19) United States
(12) Patent Application Publication
(10) Pub. No.: US 2026/0234041 A1
(43) Pub. Date: Aug. 13, 2026

(54) ULTRAPURE WATER PRODUCTION SYSTEM

(71) Applicant: Nomura Micro Science Co., Ltd., Atsugi-Shi, Kanagawa (JP)

(72) Inventor: Masamitsu IIYAMA, Atsugi-Shi, Kanagawa (JP)

(73) Assignee: Nomura Micro Science Co., Ltd., Atsugi-Shi, Kanagawa (JP)

(21) Appl. No.: 19/470,871

(22) PCT Filed: Aug. 1, 2024
(86) PCT No.: PCT/JP2024/027595

§ 371 Date: Sep. 30, 2025

(30) Foreign Application Priority Data
Sep. 27, 2023 (JP) 2023-166244

(51) Int. Cl. C02F 9/00; C02F 1/00; C02F 101/38; C02F 103/04; C02F 103/34

(52) U.S. Cl. CPC C02F 9/00; C02F 1/008; C02F 2101/38; C02F 2103/04; C02F 2103/346; C02F 2209/40

(57) ABSTRACT

An ultrapure water production method includes: a pretreatment of obtaining pretreated water by removing suspended substances from raw water containing clean water; a primary treatment of producing primary pure water by removing all organic carbon components and ionic components from the pretreated water; and a secondary treatment of producing ultrapure water by removing impurities from the primary pure water, in which second raw water that contains sewage treatment water is merged with the raw water or the pretreated water at the upstream side of the primary treatment.

### TECHNICAL FIELD

The present disclosure relates to an ultrapure water production system.

### BACKGROUND ART

There are disclosed techniques utilizing clean water as raw water and drainage water (also called recovered water in some cases) of ultrapure water used in manufacturing of semiconductors or the like in an ultrapure water production system that supplies ultrapure water to facilities for manufacturing semiconductors or the like (see Japanese Patent Application Laid-Open (JP-A) No. H06-233997, Japanese Patent Application Laid-Open (JP-A) No. H07-313994, Japanese Patent Application Laid-Open (JP-A) No. H10-272465, Japanese Patent Application Laid-Open (JP-A) No. H11-226569, Japanese Patent Application Laid-Open (JP-A) No. 2000-189760, Japanese Patent Application Laid-Open (JP-A) No. 2006-61779, and Japanese Patent Application Laid-Open (JP-A) No. 2013-202587).

Normally, recovered water is originally ultrapure water, and is a mixture of substances used in manufacturing of semiconductors, such as an acid, an alkali, isopropyl alcohol (IPA), a surfactant, and a CMP polishing agent. Therefore, the components are relatively apparent, and it is relatively easy to treat the recovered water, and utilize the recovered water mixed with the raw water.

### SUMMARY OF INVENTION

### Technical Problem

However, a large amount of ultrapure water is used in manufacturing of semiconductors or the like, and therefore, the amount of clean water to be used in the production of ultrapure water is also large. Since there is a limit on the amount of clean water supply, measures for reducing the amount of clean water to be used in ultrapure water production are required so that clean water will not be short in other applications. Since there also is a limit to utilization of recovered water, the use of the raw water can be effectively reduced, but it is not possible to sufficiently cope with an increase in the scale of the today's foundries for manufacturing semiconductors or the like.

Further, with the emergence of current environmental problems and climate change problems, the supply of clean water is also becoming unstable, and it is necessary to secure new raw water.

Normally, sewage water or sewage treatment water is poorer in water quality than clean water. In particular, sewage water or sewage treatment water contains persistent substances such as urea, and also contains large amounts and a large number of kinds of other substances. Persistent substances typified by urea tend to require a large-scale removal device that is difficult to put into practical use, and even a small amount of persistent substances might reach the end of a water purifying device. Furthermore, the range of fluctuation of water quality is wide, and the amount of water is not stable. Therefore, it is not common to use sewage water or sewage treatment water as the raw water of ultrapure water for manufacturing semiconductors or the like.

The disclosure is to reduce the proportion of clean water in raw water to be used in ultrapure water production.

### Solution to Problem

An ultrapure water production method according to a first aspect includes: a pretreatment of obtaining pretreated water by removing suspended substances from raw water containing clean water; a primary treatment of producing primary pure water by removing all organic carbon components and ionic components from the pretreated water; and a secondary treatment of producing ultrapure water by removing impurities from the primary pure water, wherein second raw water that contains sewage treatment water is merged with the raw water or the pretreated water at an upstream side of the primary treatment.

By this ultrapure water production method, the second raw water containing drainage water from a sewage treatment plant, in addition to raw water using clean water, is used to produce ultrapure water. Accordingly, the proportion of the clean water in the raw water to be used in the ultrapure water production can be lowered.

A second aspect is the ultrapure water production method according to the first aspect, in which an amount of the second raw water to be merged with the raw water or the pretreated water is configured such that a weighted average of a urea concentration in the raw water or the pretreated water and a urea concentration in the second raw water becomes equal to or lower than a urea concentration determined from an allowable urea concentration for the ultrapure water.

By this ultrapure water production method, the amount of the second raw water to be merged with the raw water is set depending on the urea concentration determined from the allowable urea concentration for the ultrapure water, and thus, the urea concentration in the ultrapure water can be restricted to be equal to or lower than the standard.

A third aspect is the ultrapure water production method according to the first aspect or the second aspect, in which, in a case in which a urea concentration in the second raw water exceeds an allowable value determined from an allowable urea concentration for the ultrapure water, the second raw water is introduced into a urea decomposition apparatus, to adjust the urea concentration to the allowable value or lower.

By this ultrapure water production method, in a case in which the urea concentration in the second raw water exceeds the allowable value determined from the allowable urea concentration for ultrapure water, the second raw water is introduced into the urea decomposition apparatus to adjust the urea concentration to the allowable value or lower, and is then merged with the raw water using clean water. Thus, sewage water can be more effectively utilized.

An ultrapure water production system according to a fourth aspect includes: a pretreatment unit that obtains pretreated water by removing suspended substances from raw water containing clean water; a primary treatment unit that produces primary pure water by removing all organic carbon components and ionic components from the pretreated water; a secondary treatment unit that produces ultrapure water by removing impurities from the primary pure water; and a urea meter that measures a urea concentration in second raw water containing sewage treatment plant water, wherein the second raw water having a urea concentration equal to or lower than an allowable value is merged with the raw water or the pretreated water at an upstream side of the primary treatment unit.

In this ultrapure water production system, the second raw water that contains drainage water from a sewage treatment plant and has a urea concentration equal to or lower than the allowable value, in addition to raw water using clean water, is used to produce ultrapure water. Accordingly, the proportion of the clean water in the raw water to be used in the ultrapure water production can be lowered.

A fifth aspect is the ultrapure water production system according to the fourth aspect, which further includes a urea decomposition unit that includes a urea decomposition apparatus that decomposes urea in the second raw water, and that introduces the second raw water into the urea decomposition apparatus to lower the urea concentration in a case in which the urea concentration exceeds an allowable value determined from an allowable urea concentration for the ultrapure water.

In this ultrapure water production system, in a case in which the urea concentration in the second raw water exceeds the allowable value determined from the allowable urea concentration for ultrapure water, the second raw water is introduced into the urea decomposition apparatus to adjust the urea concentration to the allowable value or lower, and is then merged with the raw water using clean water. Thus, sewage water can be more effectively utilized.

A sixth aspect is the ultrapure water production system according to the fourth aspect or the fifth aspect, in which an amount of the second raw water to be merged with the raw water or the pretreated water is configured such that a weighted average of a urea concentration in the raw water or the pretreated water and the urea concentration in the second raw water becomes equal to or lower than an allowable value determined from an allowable urea concentration for an allowable urea concentration for the ultrapure water.

In this ultrapure water production system, the amount of the second raw water to be merged with the raw water is set depending on the urea concentration determined from the allowable urea concentration for the ultrapure water, and thus, the urea concentration in the ultrapure water can be restricted to be equal to or lower than the standard.

### Advantageous Effects of Invention

According to the disclosure, the proportion of clean water in the raw water to be used in ultrapure water production can be reduced.

### BRIEF DESCRIPTION OF DRAWINGS

FIG. 1 is a block diagram showing an outline of an ultrapure water production system according to the present embodiment.

FIG. 2 is a block diagram showing an outline of an ultrapure water production system according to a modification of the present embodiment.

FIG. 3 is a block diagram showing an example configuration of a urea meter.

FIG. 4 is a line chart showing an example of a change in urea concentration in second raw water over time, and conditions for acceptance of the second raw water.

### DESCRIPTION OF EMBODIMENTS

In the following, modes for carrying out the disclosure will be described with reference to the drawings. Components denoted by the same reference numerals in the respective drawings are the same or similar components. Note that repetitive descriptions and reference numerals in the embodiments described below will be omitted in some cases. Further, all of the drawings used in the following description are schematic, and the dimensional relationships among the respective elements, the proportions of the respective elements, and the like illustrated in the drawings do not necessarily coincide with actual ones. Furthermore, the dimensional relationships among the respective elements, the proportions of the respective elements, and the like are not necessarily the same between the drawings.

In the following, modes for carrying out the disclosure will be described with reference to the drawings.

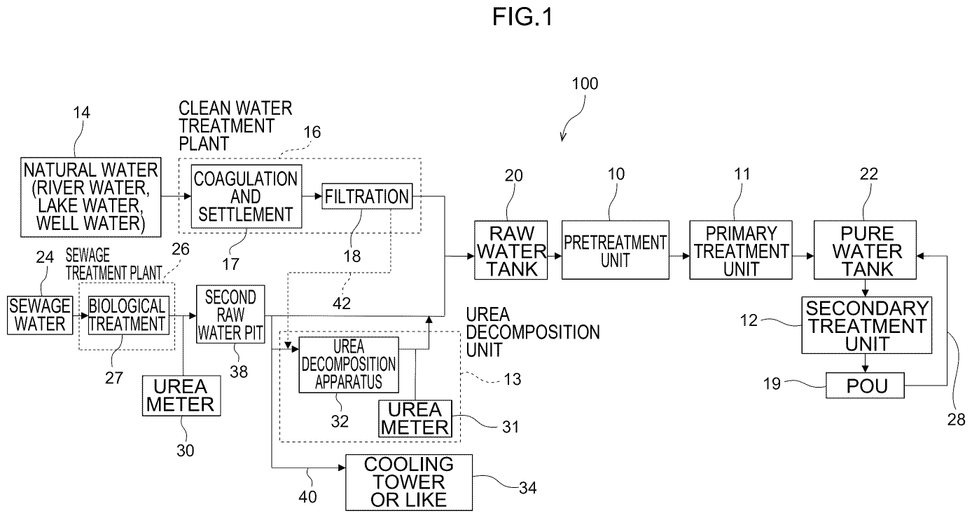

In FIG. 1, an ultrapure water production system 100 according to the present embodiment can produce ultrapure water by receiving second raw water derived from sewage, in addition to raw water derived from natural water, which is city water, industrial water, and the like. The ultrapure water production system 100 includes a pretreatment unit 10, a primary treatment unit 11, a secondary treatment unit 12, and a urea meter 30. The ultrapure water production system 100 may further include a urea decomposition unit 13.

The pretreatment unit 10 is an apparatus that removes suspended substances from raw water (first raw water) containing clean water to obtain pretreated water. As an example, impurities such as residual chlorine and large-size wastes in the raw water are removed by sand filtration or the like filled with media such as filtration sand, a filling tank filter tower such as a multimedia filter tower (MMF), a membrane filtration device using a filter such as a microfilter (MF) or an ultrafiltration membrane (UF), and/or a granular activated carbon tower or the like. The raw water containing clean water is so-called tap water obtained by subjecting natural water 14, which is river water, lake water, well water, or the like, to a coagulation-settlement step 17 and a filtration step 18 at a clean water treatment plant 16. The raw water is stored in a raw water tank 20, for example, and is used for ultrapure water production.

The primary treatment unit 11 is an apparatus that removes all organic carbon (TOC) components and ionic components from the pretreated water to produce primary pure water. As an example, primary pure water is purified by combining a reverse osmosis membrane apparatus that subjects the pretreated water to reverse permeation using a semipermeable membrane, an ion-exchange resin apparatus or an electric deionizer (EDI) filled with ion-exchange resin, an ultraviolet irradiation apparatus that decomposes organic substances, a degassing membrane apparatus that removes dissolved gases, and the like. In the primary treatment unit 11, a urea decomposition apparatus such as a high-pressure reverse osmosis membrane apparatus or an oxidation reaction tank in which urea decomposition is conducted through addition of hypobromous acid or the like may be installed if necessary. The produced primary pure water is supplied to a pure water tank 22.

The secondary treatment unit 12 is an apparatus that further removes impurities from the primary pure water to produce ultrapure water, and for example, removes inorganic ions contained in a trace amount in the primary pure water with a non-regenerative ion exchange tower (polisher), for example. Further, an ultraviolet irradiation apparatus, a hydrogen peroxide decomposing apparatus, a degassing apparatus, and the like are combined. An ultrafiltration membrane is set at the end of the secondary treatment unit 12, to remove fine particles. The produced ultrapure water is supplied to a place of use (POU) 19, is used for semiconductor manufacturing or the like, and is partially circulated into the pure water tank 22 by a circulation line 28.

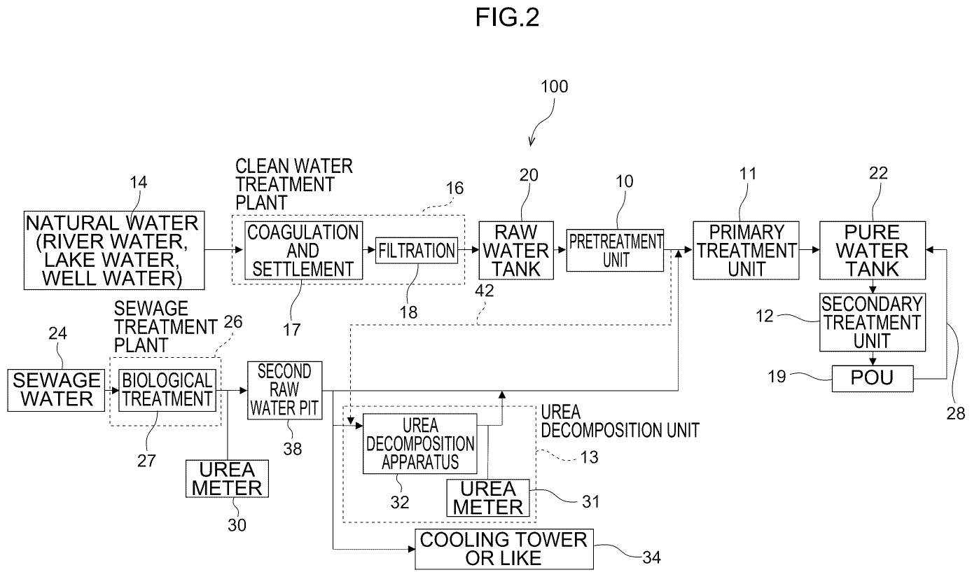

The second raw water is water containing sewage treatment water obtained by subjecting sewage water 24 to a biological treatment step 27 at a sewage treatment plant 26. The second raw water having a urea concentration equal to or lower than an allowable value determined from the allowable urea concentration for ultrapure water joins the raw water or the pretreated water at the upstream side of the primary treatment unit 11. In the example illustrated in FIG. 1, the second raw water joins the raw water and is stored in a raw water tank 20. In a modification illustrated in FIG. 2, the second raw water joins the pretreated water between the pretreatment unit 10 and the primary treatment unit 11. The pretreatment unit 10 is not an apparatus intended to remove urea, and the removal of suspended substances at the pretreatment unit 10 has already been performed at the sewage treatment plant. Therefore, the raw water and the second raw water may merge at the position shown in Modification 2.

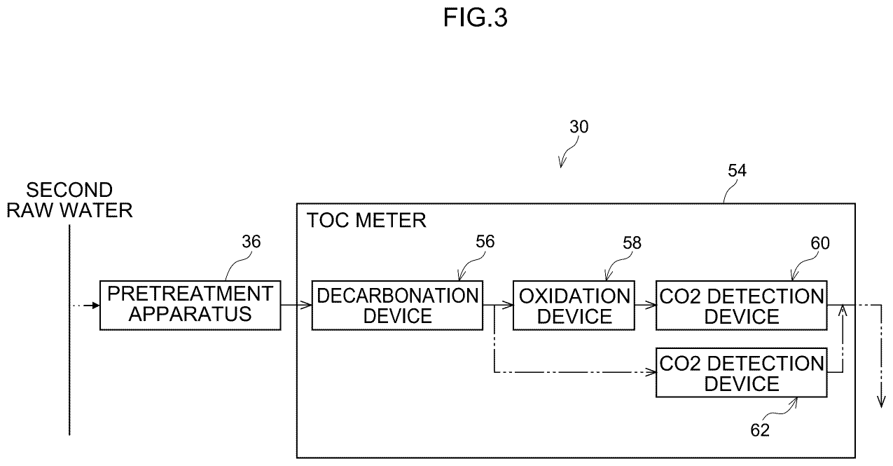

As the urea meter 30, one shown as an example in FIG. 3 that measures the urea concentration in the second raw water containing sewage treatment water can be used, for example. Here, the urea meter 30 includes a pretreatment apparatus 36 and a TOC meter 54. The pretreatment apparatus 36 is formed with an ultraviolet irradiation apparatus, a reverse osmosis membrane apparatus, or an ion-exchange apparatus, for example. Since the second raw water contains urea and TOC components other than urea, the TOC components other than urea are removed. The TOC meter 54 includes a decarbonation device 56, an ultraviolet oxidation device 58, a CO₂ detection device 60, and a CO₂ detection device 62. The TOC meter 54 is a device that measures the concentration of urea in the second raw water from which the TOC components other than urea have been removed, as TOC. Also, the measurement target liquid is not necessarily the second raw water that is sewage treatment water, and the second raw water treated by a urea decomposition apparatus 32, the ultrapure water obtained at the secondary treatment unit 12, or any other liquid obtained during each intermediate process in the ultrapure water production system 100 can be used as the measurement target liquid.

In the decarbonation device 56 of the TOC meter 54, a hollow fiber (vacuum degassing) module or the like is used to remove carbonic acid from the measurement target liquid, for example. Specifically, phosphoric acid is added to the measurement target liquid, and the measurement target liquid then permeates through a gas permeable membrane having its one side evacuated. Note that, in a case in which the concentration of carbonic acid in the measurement target liquid to be sent to the TOC meter 54 is low, and the influence on CO₂ detection is small, the removal of carbonic acid by the decarbonation device 56 may be skipped.

Alternatively, as the TOC meter 54, one without the decarbonation device 56 may be used. In this case, if it is necessary to remove carbonic acid from the measurement target liquid, the decarbonation device 56 can be provided in front (on the upstream side) of the TOC meter 54, for example. Examples of such a decarbonation device 56 include degassing devices, and a vacuum degassing membrane, a degassing tower, a vacuum degassing tower, or the like can be a candidate, but a vacuum degassing membrane is preferable.

Before the measurement target liquid is supplied to the decarbonation device 56, pH adjustment may be performed if necessary. In a case where a degassing device is used as the decarbonation device 56, it is preferable to make the measurement target liquid acidic (the pH is 5 or lower, for example), because the carbonic acid removal rate will increase. The pH adjustment can be performed by adding a known acid, for example. Further, in a case where a reverse osmosis membrane (RO) or an ion exchange device is used for the filtration device 50 described above, for example, if hydroxide ions are present in the measurement target liquid, the hydroxide ions can be removed, and thus, at least part of the pH adjustment can be performed by the filtration device.

In the TOC meter 54, the flow path of the measurement target liquid is split on the downstream side of the decarbonation device 56, and the oxidation device 58 and the CO₂ detection device 60 are provided in one flow path while the CO₂ detection device 62 is provided in the other flow path.

For example, the oxidation device 58 of the TOC meter 54 irradiates the measurement target liquid with ultraviolet rays, to oxidize organic substances contained in the measurement target liquid, including urea. Actually, most of the components other than urea among the organic substances contained in the measurement target liquid have been removed, and therefore, the organic substance to be oxidized by the oxidation device 58 is urea. That is, at the oxidation device 58, urea in the measurement target liquid is oxidatively decomposed, and carbon dioxide is newly generated at this stage.

The CO₂ detection devices 60 and 62 of the TOC meter 54 measure the amount of carbon dioxide in the treatment target liquid. The amount of carbon dioxide is proportional to the amount of carbon contained in the organic substance in the oxidatively decomposed measurement target liquid.

Here, on the upstream side of the CO₂ detection device 60, the organic substance in the measurement target liquid has been oxidized by the oxidation device 58, and the CO₂ detection device 60 detects the all carbon concentration in the measurement target liquid. On the other hand, on the upstream side of the CO₂ detection device 62, the organic substance in the measurement target liquid has not been oxidized by the oxidation device 58, and the CO₂ detection device 62 detects the inorganic carbon concentration in the measurement target liquid. In the TOC meter 54, as shown below in Expression (1), the all organic carbon concentration in the measurement target liquid is obtained by subtracting the inorganic carbon concentration detected by the CO₂ detection device 62 from the all carbon concentration detected by the CO₂ detection device 60.

$$All organic carbon concentration = all carbon concentration - inorganic carbon concentration \qquad ( 1 )$$

Note that, in a case in which the carbonic acid removal rate in the decarbonation device 56 is high, part of the urea might have been removed before reaching the oxidation device 58 of the TOC meter 54. In such a case, these urea removal rates are examined in advance, and the results of the urea concentration measurement by the TOC meter 54 are corrected accordingly, so that the urea concentration can be obtained more accurately.

Further, the specific configuration of the TOC meter 54 is not limited to the above, and various kinds of TOC meters can be used in the present embodiment.

The treatment target liquid after the all organic carbon concentration is measured by the TOC meter 54 may be discarded as waste liquid, or may be returned to the line of the second raw water, for example.

The urea concentration measurement process at the TOC meter 54 may be a continuous process that is performed while the measurement target liquid continuously flows, or may be a batch-type process that is performed while the measurement target liquid is temporarily stored.

In a case in which the urea concentration measurement process at the TOC meter 54 is of the batch type, the measurement target liquid may be supplied more frequently or continuously than in the measurement at the TOC meter 54. Also, the measurement target liquid may be supplied at a higher flow rate than required in the urea concentration measurement process at the TOC meter 54. In that case, the measurement target liquid that is not supplied to the TOC meter 54 may be discharged through a drain tube that is provided immediately before the TOC meter 54, for example.

As the measurement target liquid is supplied to the pipe at a high flow rate or/and with high frequency or continuously, it is possible to prevent generation of bacteria and adhesion of organic substances onto the sidewall of the pipe. Generated bacteria and adhering organic substances might separate from the sidewall at unexpected timing and flow into the measurement target liquid, resulting in a decrease in urea concentration measurement accuracy.

The urea meter 30 is not limited to the one described above, and some commercially available device may be used.

The urea decomposition unit 13 includes the urea decomposition apparatus 32 that decomposes the urea in the second raw water. In a case in which the urea concentration in the second raw water exceeds the allowable value determined from the allowable urea concentration for ultrapure water, the second raw water is introduced into the urea decomposition apparatus 32, to lower the urea concentration. To measure the urea concentration in the second raw water having passed through the urea decomposition apparatus 32, the urea decomposition unit 13 may have a urea meter 31 similar to the urea meter 30 described above on the downstream side of the urea decomposition apparatus 32.

As a means for decomposing urea at the urea decomposition apparatus 32, the methods as described below can be used, for example, and one of the methods can be selected and used as appropriate, depending on the scale of the pure water apparatus and the water quality of the second raw water.
1) Biological treatment
2) Biological activated carbon treatment
3) Oxidative decomposition treatment with oxidizing agent (bromic acid, hypobromous acid, or the like)
4) Urea decomposition treatment with reducing agent (sulfurous acid)
5) High-pressure reverse osmosis (RO) treatment
6) Ultraviolet irradiation treatment, and treatment using both ultraviolet irradiation and oxidizing agent

In the methods 1 and 2, organisms are used, and therefore, it is difficult to perform stable treatment. However, by these methods combined with the present method, ultrapure water production can be continued even in a case in which the performance of the biological treatment is degraded. Further, if a pit is provided before biological treatment tank, and the urea in the second raw water is decomposed little by little in the biological treatment tank, stable treatment can be expected.

With the method 3, the amount of the oxidizing agent to be added is normally large, and a large amount of the oxidizing agent after the reaction remains. Therefore, it is necessary to remove the remaining oxidizing agent, and the apparatus becomes larger in scale. In the present embodiment, however, the urea decomposition apparatus 32 is provided in a branch line of the second raw water, and thus, the apparatus can be made smaller in size. Further, if a pit is formed in the stage before the oxidative decomposition apparatus, and the second raw water is decomposed little by little therein, downsizing can also be achieved.

With the methods 4, 5, and 6, the apparatus becomes larger in scale, and, with the method 5, the removal rate presents a problem. In the present embodiment, however, the urea decomposition apparatus 32 is provided in a branch line of the second raw water, and thus, the apparatus can be made smaller in size.

The method 4 is implemented as described below, using an ultraviolet irradiation apparatus, for example. Oxidative decomposition is promoted by irradiating the water to be treated (the second raw water) having a reducing agent added thereto, with ultraviolet rays. The wavelength of the ultraviolet rays may be any wavelength with which the water to be treated can be oxidized. For example, the ultraviolet rays may be ultraviolet rays having a wavelength of about 185 nm, which is generally used for ultraviolet oxidation, or may be ultraviolet rays having a wavelength of about 254 nm, which is used for sterilization.

Note that it is considered that the reducing agent added to the water to be treated is changed to a persulfuric acid radical or an active species in a form close to the persulfuric acid radical by the action of ultraviolet rays. Urea is then decomposed by the generated active species.

Further, as a method other than the above 1) to 6), it is also possible to use a urea-degrading enzyme, a catalyst carrying a urea-degrading enzyme, or the like.

The amount of the second raw water to be merged with the raw water or the pretreated water, which is the second raw water to be accepted in the ultrapure water production, is configured such that a weighted average of the urea concentration in the raw water or the pretreated water and the urea concentration in the second raw water (which is the urea concentration after the mixing) becomes equal to or lower than the allowable value determined from the urea concentration (urea specification) required for ultrapure water. The amount of the second raw water to be accepted in the raw water tank 20 may be determined by back calculation, with the removal rate of urea from the junction to the secondary treatment unit 12 being taken into account. That is, the weighted average of the urea concentration may be calculated by back calculation from the allowable urea concentration for ultrapure water to the urea concentration at the junction of the raw water and the second raw water, to set the amount of the second raw water to be accepted in the raw water tank 20. Note that, in a case in which the urea concentration in the second raw water is equal to or lower than the allowable value, the second raw water can be accepted in ultrapure water production, without being mixed with the raw water. That is, even when the second raw water is 100%, ultrapure water production can be performed.

Further, it is also possible to store the second raw water in which the urea concentration exceeds the allowable value into a second raw water pit 38, return the treated water in the urea decomposition apparatus 32 into the second raw water pit 38 through a return line (not illustrated) for the second raw water pit 38, and thus conduct the circulation. As a result, the urea concentration in the second raw water in the second raw water pit 38 drops. When the value of the urea meter 30 becomes sufficiently lower, the second raw water can be supplied to the raw water tank 20 or the primary treatment unit 11. Note that, in a case in which the urea concentration in the second raw water drops during the circulating operation, the second raw water can be supplied to the raw water tank 20 or the primary treatment unit 11 through a bypass line (not shown) for the second raw water pit 38.

In a case in which the urea concentration in the second raw water is conspicuously high, and urea cannot be decomposed even with the urea decomposition apparatus 32, the second raw water can be supplied to a cooling tower or the like 34 via a cooling tower supply line 40, and be used as cooling tower water or the like. Note that the cooling tower supply line 40 may be installed so as to branch from the stage before the second raw water pit 38.

Furthermore, the water quality of the raw water containing clean water might temporarily vary significantly immediately after a typhoon or the like, for example. Coping with such a situation is also possible.

In this case, the amount of use of the second raw water can be increased to cope with the situation, for example. Other than that, a supply line 42 of the raw water containing clean water to the urea decomposition apparatus 32 is used to decompose the urea in the raw water containing clean water, so that the raw water containing clean water is used as the raw water. In this case, it is possible to cope with the temporary degradation of the water quality of the raw water containing clean water, without providing any specific facility.

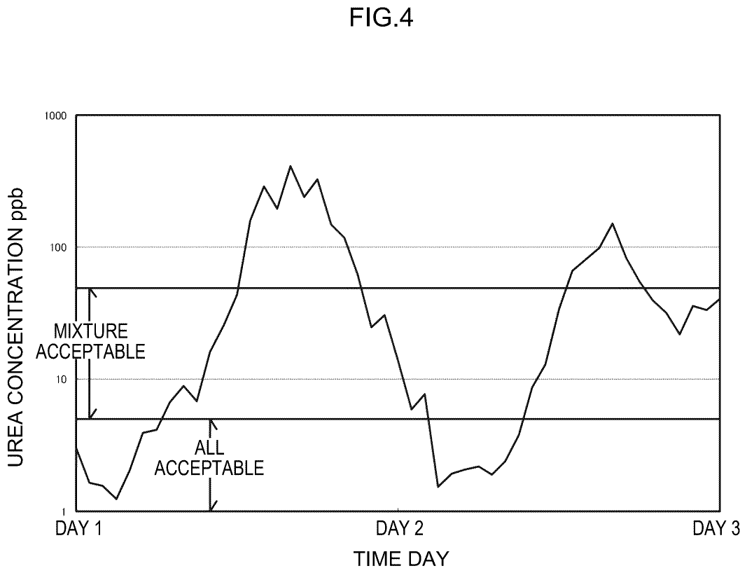

FIG. 4 shows an example of a change in urea concentration in sewage water (the second raw water) over time, and conditions for acceptance of the second raw water. Where the urea removal rate in the ultrapure water production system 100 is 90%, the urea concentration in the raw water is 0.1 ppb, and the urea concentration (urea specification) required for ultrapure water is 0.5 ppb, all the second raw water can be accepted in the ultrapure water production if the urea concentration in the second raw water is 5 ppb or lower. The “all acceptable” in FIG. 4 indicates this range. Further, in a case in which the mixing ratio between the raw water and the second raw water is 9:1, and the second raw water exceeding this mixing ratio is not to be accepted, the urea concentration in the second raw water is allowed to be 49 ppb at a maximum. The “mixture acceptable” in FIG. 4 indicates this range. In this case, 43% of the raw water required for producing ultrapure water can be used as the second raw water.

### Ultrapure Water Production Method

An ultrapure water production method according to the present embodiment includes: a pretreatment of obtaining pretreated water by removing suspended substances from raw water containing clean water; a primary treatment of producing primary pure water by removing all organic carbon (TOC) components and ionic components from the pretreated water; and a secondary treatment of producing ultrapure water by removing impurities from the primary pure water, in which second raw water that contains sewage treatment water and has a urea concentration equal to or lower than an allowable value determined from the allowable urea concentration for the ultrapure water is merged with the raw water or the pretreated water at the upstream side of the primary treatment unit.

Here, in a case in which the urea concentration in the second raw water exceeds the allowable value determined from the allowable urea concentration for the ultrapure water, the second raw water may be introduced into the urea decomposition apparatus, to adjust the urea concentration to the allowable value or lower.

Further, the amount of the second raw water to be merged with the raw water or the pretreated water may be configured such that a weighted average of the urea concentration in the raw water or the pretreated water and the urea concentration in the second raw water becomes equal to or lower than the allowable urea concentration for the ultrapure water.

### Effects

The present embodiment is configured as described above, and the effects thereof are described below. In the ultrapure water production system 100 according to the present embodiment, second raw water containing sewage treatment water, in addition to raw water using clean water, is used to produce ultrapure water. Accordingly, the proportion of the clean water in the raw water to be used in the ultrapure water production can be lowered.

Further, in a case in which the urea concentration in the second raw water exceeds the allowable value determined from the allowable urea concentration for ultrapure water, the urea decomposition unit 13 is used, and the second raw water is introduced into the urea decomposition apparatus 32, to adjust the urea concentration to the allowable value or lower. After that, the second raw water is merged with the raw water using clean water. Thus, sewage water can be more effectively utilized.

Further, the amount of the second raw water to be merged with the raw water is set depending on the allowable urea concentration for ultrapure water, and thus, the urea concentration in the ultrapure water can be restricted to be equal to or lower than the standard.

Furthermore, in a case in which the urea decomposition apparatus 32 is set before the raw water and the second raw water are mixed, it is possible to reduce size, compared with that in a case in which the urea decomposition apparatus 32 is set after the raw water and the second raw water are mixed. In particular, in a case in which the urea decomposition apparatus 32 is set closer to the primary treatment unit 11 or the pretreatment unit 10 than the merging point of the raw water and the second raw water, it is necessary to design the urea decomposition apparatus 32 so that the urea concentration in ultrapure water falls within the specification even if the urea concentration reaches the maximum value. As a result, the urea decomposition apparatus 32 becomes very large. Therefore, the installation area is large, and, at the same time, the running cost is high. In the case of the embodiment illustrated in FIG. 1, it is possible to cope with a situation, using a smallest possible apparatus, with the rate of utilization of the second raw water being taken into account. This rate can be set to about ½ to 1/10, depending on the water quality and variation of water quality of sewage water, and the target rate of utilization of sewage water.

Furthermore, even if the urea concentration in the second raw water becomes higher than the designed value, the second raw water is used in the cooling tower or the like 34, and the ultrapure water production system 100 only needs to operate with the first raw water. Accordingly, there is an advantage in that there is no need to stop the production of ultrapure water.

Further, the second raw water is used after mixing of the raw water and the second raw water, and thus, it is possible to minimize the equipment to be newly installed.

As described above, according to the present embodiment, the proportion of clean water in the raw water to be used in ultrapure water production can be reduced. Because of this, the amount of clean water to be used in semiconductor manufacturing can also be reduced. That is, an improved ultrapure water production method can be provided.

Note that, other than urea, possible persistent substances include a urea derivative and an organic fluorine compound such as perfluorooctasulfonic acid (PFOS) or perfluorooctanoic acid (PFOA), but the disclosure can also be suitably applied in a case in which these substances are contained.

### Other Embodiments

Although an example of an embodiment of the disclosure has been described so far, embodiments of the disclosure are not limited to the above, and it is needless to say that various modifications other than the above can be made thereto, without departing from the scope of the disclosure.

The disclosure of Japanese Patent Application No. 2023-166244, filed on Sep. 27, 2023, is incorporated herein by reference in their entirety.

All literatures, patent applications, and technical standards mentioned in this specification are incorporated herein by reference to the same extent as that in a case where each literature, each patent application, and each technical standard are specifically and individually mentioned to be incorporated by reference.

### REFERENCE SIGNS LIST

10 Pretreatment unit
11 Primary treatment unit
12 Secondary treatment unit
13 Urea decomposition unit
19 Place of use (POU)
20 Raw water tank
30 Urea meter
32 Urea decomposition apparatus
100 Ultrapure water production system

1. An ultrapure water production method, comprising:
a pretreatment of obtaining pretreated water by removing suspended substances from raw water containing clean water;
a primary treatment of producing primary pure water by removing all organic carbon components and ionic components from the pretreated water; and
a secondary treatment of producing ultrapure water by removing impurities from the primary pure water,
wherein second raw water that contains sewage treatment water is merged with the raw water or the pretreated water at an upstream side of the primary treatment.

2. The ultrapure water production method according to claim 1, wherein an amount of the second raw water to be merged with the raw water or the pretreated water is configured such that a weighted average of a urea concentration in the raw water or the pretreated water and a urea concentration in the second raw water becomes equal to or lower than an allowable value determined from an allowable urea concentration for the ultrapure water.

3. The ultrapure water production method according to claim 1, wherein, in a case in which a urea concentration in the second raw water exceeds an allowable value determined from an allowable urea concentration for the ultrapure water, the second raw water is introduced into a urea decomposition apparatus.

4. An ultrapure water production system, comprising:
a pretreatment unit that obtains pretreated water by removing suspended substances from raw water containing clean water;
a primary treatment unit that produces primary pure water by removing all organic carbon components and ionic components from the pretreated water;
a secondary treatment unit that produces ultrapure water by removing impurities from the primary pure water; and
a urea meter that measures a urea concentration in second raw water containing sewage treatment water,
wherein the second raw water is merged with the raw water or the pretreated water at an upstream side of the primary treatment unit.

5. The ultrapure water production system according to claim 4, further comprising a urea decomposition unit that includes a urea decomposition apparatus that decomposes urea in the second raw water, and that introduces the second raw water into the urea decomposition apparatus to lower the urea concentration in a case in which the urea concentration exceeds an allowable value determined from an allowable urea concentration for the ultrapure water.

6. The ultrapure water production system according to claim 4, wherein an amount of the second raw water to be merged with the raw water or the pretreated water is configured such that a weighted average of a urea concentration in the raw water or the pretreated water and the urea concentration in the second raw water becomes equal to or lower than an allowable value determined from an allowable urea concentration for the ultrapure water.
